(19) United States
(12) Patent Application Publication
(10) Pub. No.: US 2018/0300635 A1
(43) Pub. Date: Oct. 18, 2018

(54) COGNITIVE KNOWLEDGE BASED REGISTRATION SYSTEM FOR GEOMECHANICAL DATA

(71) Applicant: International Business Machines Corporation, Armonk, NY (US)

(72) Inventors: Paul Borrel, RIO DE JANEIRO (BR); Paulo Rodrigo Cavalin, RIO DE JANEIRO (BR); Matthias Kormaksson, RIO DE JANEIRO (BR); Carmen Nilda Mena Paz, RIO DE JANEIRO (BR)

(21) Appl. No.: 15/490,873

(22) Filed: Apr. 18, 2017

(51) Int. Cl. G06N 5/02; G06F 17/30

(52) U.S. Cl. CPC G06N 5/022; G06N 3/08; G06F 17/30

(57) ABSTRACT

An embodiment includes a method for use in importing geomechanical data from one or more references into a knowledge base. The method includes selecting at least one chart within at least a given one of the one or more references; extracting at least a subset of the geomechanical data in the selected chart; preparing one or more learnable models at least in part from the geomechanical data; and loading the learnable models into the knowledge base for use at least in part by at least one machine learning classifier.

### CROSS-REFERENCE TO RELATED APPLICATION

The present invention is related to U.S. patent application Ser. No. 15/197,734 entitled “Machine Learning Assisted Reservoir Simulation,” filed Jun. 29, 2016 (hereinafter “the prior application”), the entire disclosure of which is hereby incorporated by reference herein for all purposes. The prior application was not published or otherwise publicly available as of the filing date of the present application. Moreover, each of the joint inventors named in the prior application is also named as a joint inventor in the present application.

### FIELD OF THE INVENTION

The present invention relates to the electrical, electronic and computer arts, and, more particularly, to registration of geomechanical data within a knowledge base.

### BACKGROUND OF THE INVENTION

Solutions to various problems in, for example, the petroleum industry are facilitated by the use of a knowledge base containing geomechanical data, such as stress-strain curves for one or more geomaterials. By way of example, FIGS. 4-6 of the prior application teach a technique in which such a knowledge base is used by a fracture classifier to facilitate selection of an appropriate model for simulation of a reservoir. As discussed in the prior application with reference to, e.g., steps 450 and 460 in FIG. 4; step 554 in FIG. 5; and FIG. 9, using the knowledge base in this technique requires registration of stress-strain curves for one or more geomaterials within the knowledge base. However, the prior art teaches neither a systematic methodology nor a cognitive system to achieve such knowledge registration.

### SUMMARY OF THE INVENTION

An embodiment includes a method for use in importing geomechanical data from one or more references into a knowledge base. The method includes selecting at least one chart within at least a given one of the one or more references; extracting at least a subset of the geomechanical data in the selected chart; preparing one or more learnable models at least in part from the geomechanical data; and loading the learnable models into the knowledge base for use at least in part by at least one machine learning classifier.

As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

One or more embodiments of the invention or elements thereof can be implemented in the form of a computer program product including a computer readable storage medium with computer usable program code for performing the method steps indicated. Furthermore, one or more embodiments of the invention or elements thereof can be implemented in the form of a system (or apparatus) including a memory, and at least one processor that is coupled to the memory and operative to perform exemplary method steps. Yet further, in another aspect, one or more embodiments of the invention or elements thereof can be implemented in the form of means for carrying out one or more of the method steps described herein; the means can include (i) hardware module(s), (ii) software module(s) stored in a computer readable storage medium (or multiple such media) and implemented on a hardware processor, or (iii) a combination of (i) and (ii); any of (i)-(iii) implement the specific techniques set forth herein.

Techniques of the present invention can provide substantial beneficial technical effects; e.g. a systematic methodology and/or a cognitive system to achieve knowledge registration, e.g., for a machine learning fracture classifier used to facilitate selection of an appropriate model for simulation of a reservoir. Thus, an illustrative embodiment of the invention may advantageously help professionals in interdisciplinary areas making decisions in oil exploration analysis.

These and other features and advantages of the present invention will become apparent from the following detailed description of illustrative embodiments thereof, which is to be read in connection with the accompanying drawings.

### BRIEF DESCRIPTION OF THE DRAWINGS

FIG. 1 is a simplified flowchart showing an exemplary technique according to an illustrative embodiment of the present invention;

FIG. 2 is a more detailed flowchart showing an exemplary technique according to an illustrative embodiment of the present invention;

FIG. 3 is a flowchart showing an exemplary process for information extraction according to an illustrative embodiment of the present invention;

FIG. 4 is a flowchart showing another exemplary technique;

FIGS. 5A-5D show exemplary screenshots associated with respective steps of the technique shown in FIG. 4;

FIGS. 6A-6E represent stress-strain curves found in the literature for different variants of sandstone under various conditions;

FIG. 7A shows labels used with the data shown in FIGS. 7B and 7C;

FIG. 7B shows selected sandstone curve data based on FIGS. 6A-6E;

FIG. 7C shows a normalized set of curve data based on FIG. 7B;

FIGS. 8A-8F represent stress-strain curves found in the literature for different variants of limestone under various conditions;

FIG. 9A shows labels used with the data shown in FIGS. 9B and 9C;

FIG. 9B shows selected limestone curve data based on FIGS. 8A-8F;

FIG. 9C shows a normalized set of curve data based on FIG. 9B;

FIG. 10 depicts a computer system that may be useful in implementing one or more aspects and/or elements of the invention.

### DETAILED DESCRIPTION OF PREFERRED EMBODIMENTS

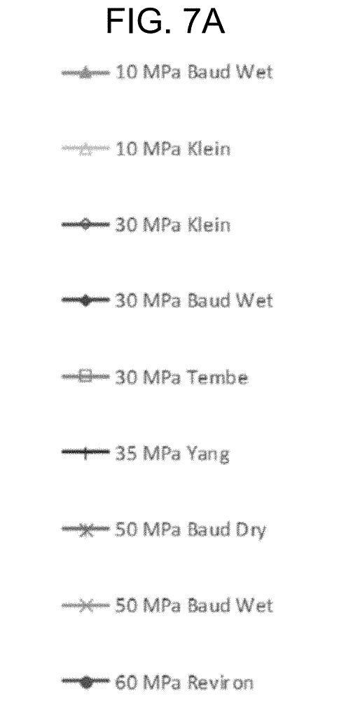

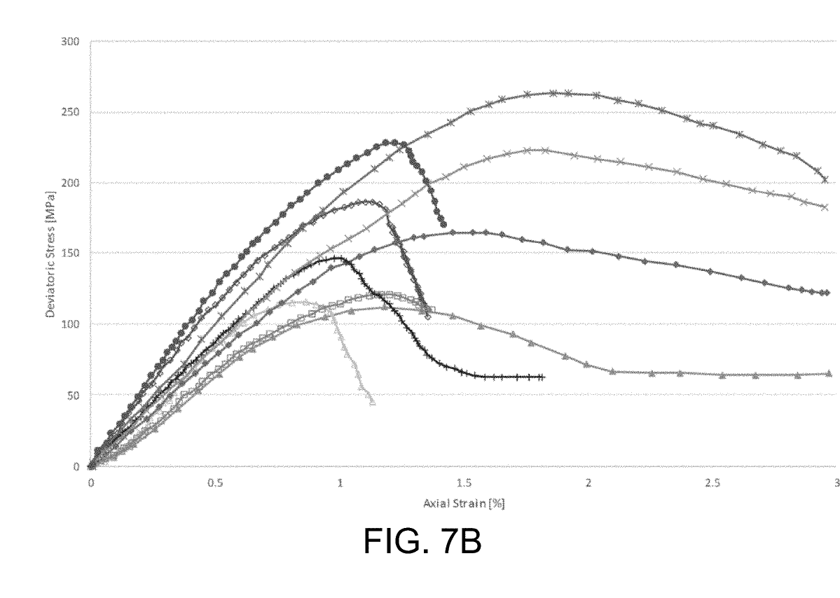

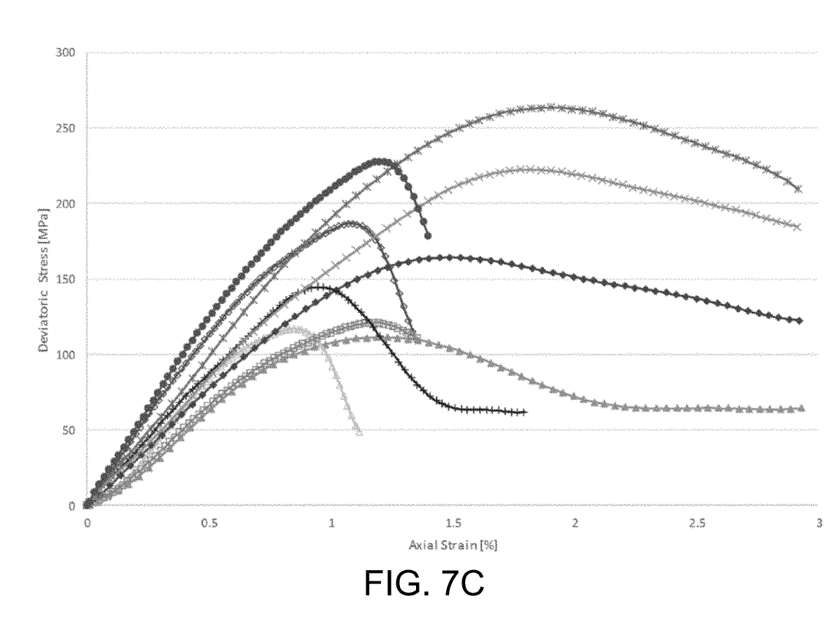

Although the inventive principles are primarily described herein with reference to a knowledge base of strain-stress curves for one or more geomaterials, such as those described in FIGS. 7-9 of the prior application, the invention is not so limited and one skilled in the art will understand that inventive techniques may be applied for registration of other types of geomechanical data within a knowledge base. Moreover, although the inventive principles discussed herein are primarily described herein with reference to a knowledge base used by a fracture classifier to facilitate selection of an appropriate model for simulation of a reservoir, such as those described in FIGS. 4-6 of the prior application, the invention is not so limited and one skilled in the art will understand that inventive techniques may be applied to knowledge bases with other content and/or utility.

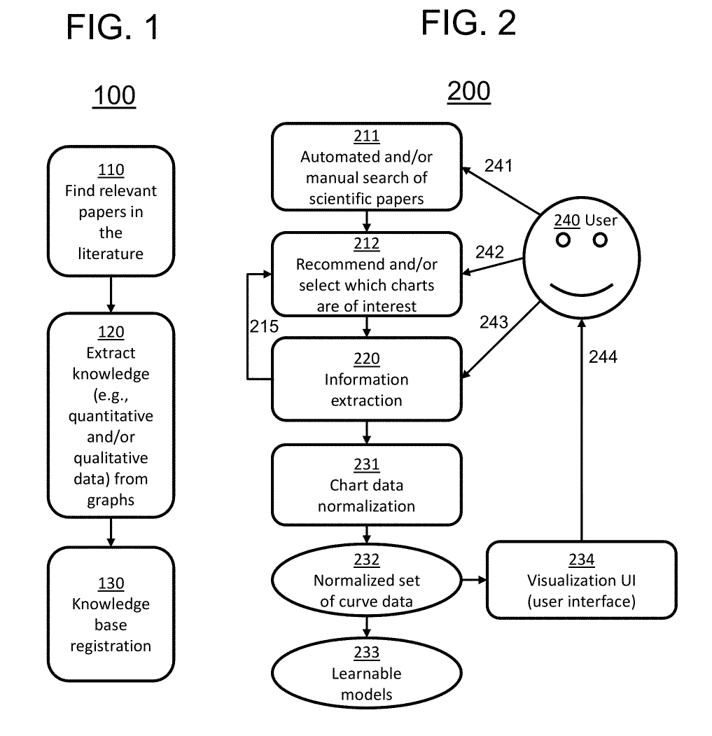

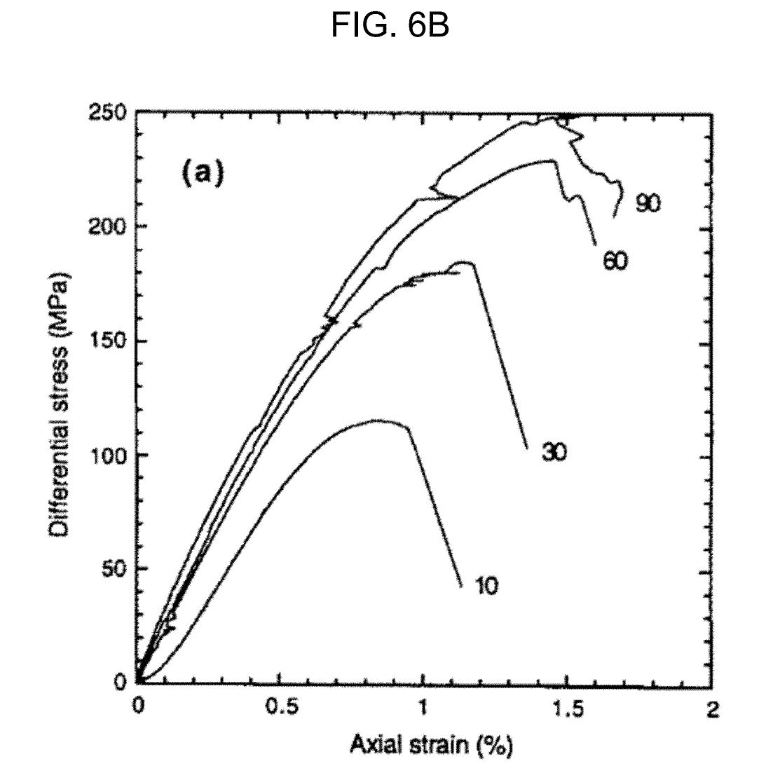

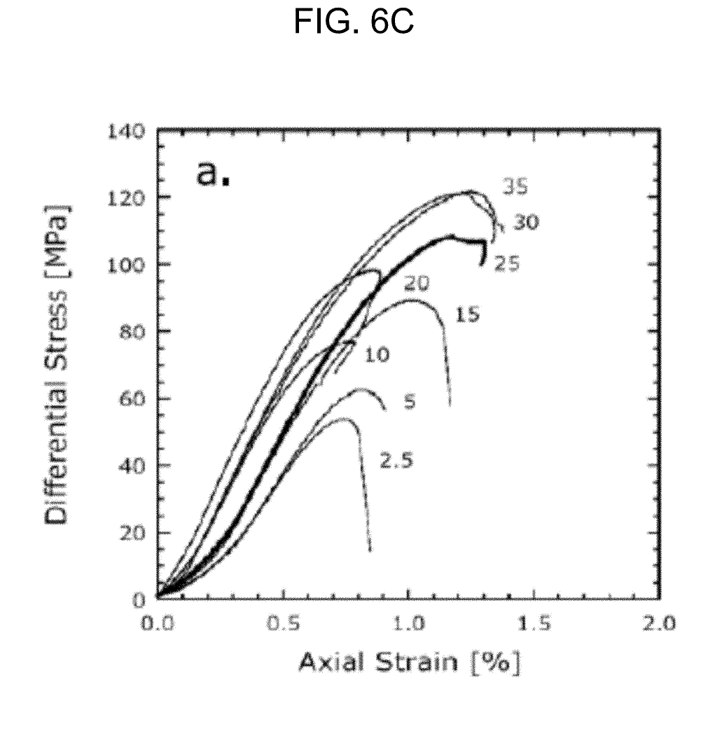

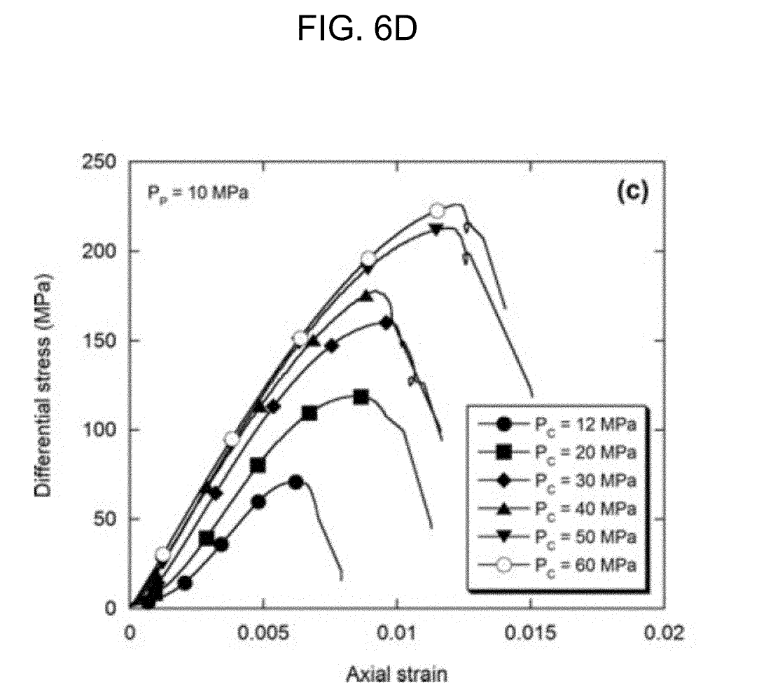

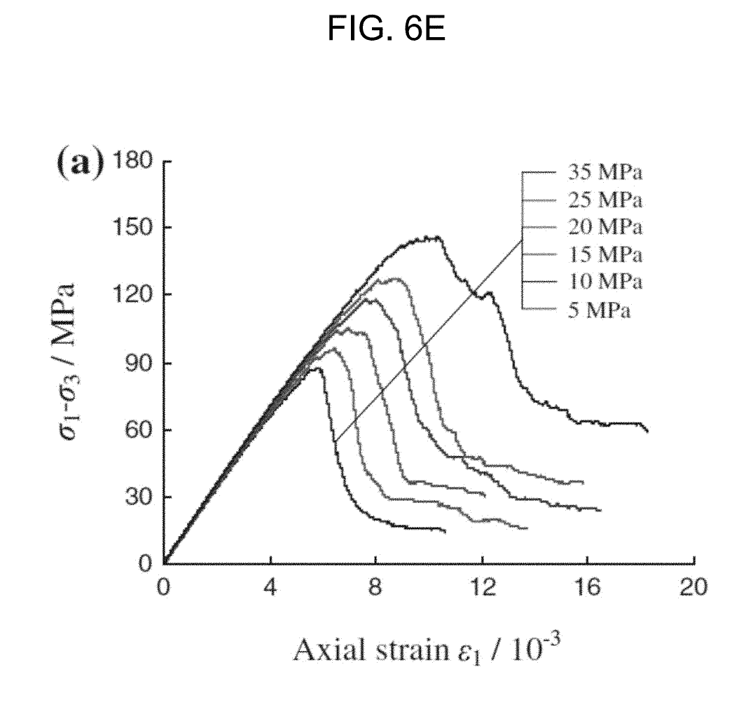

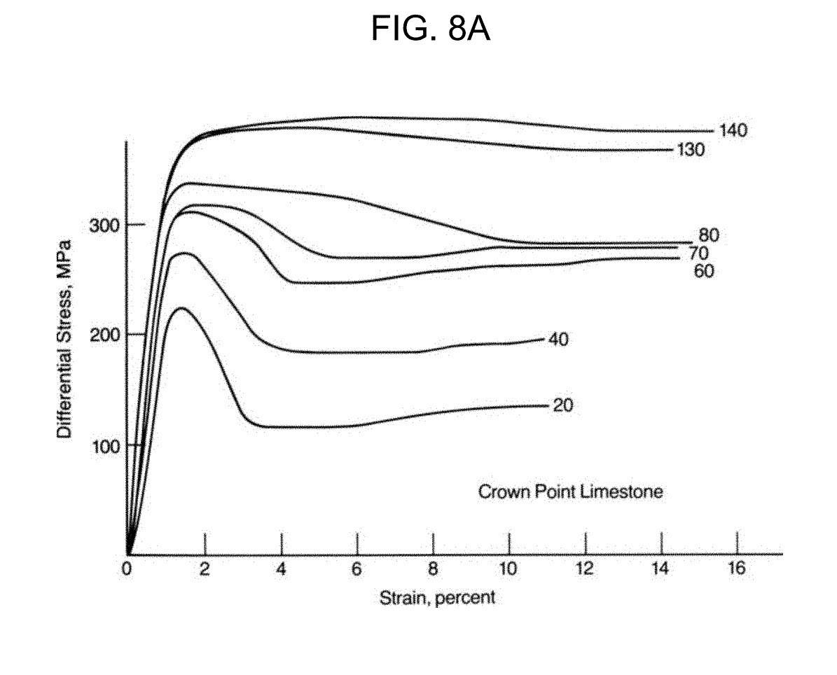

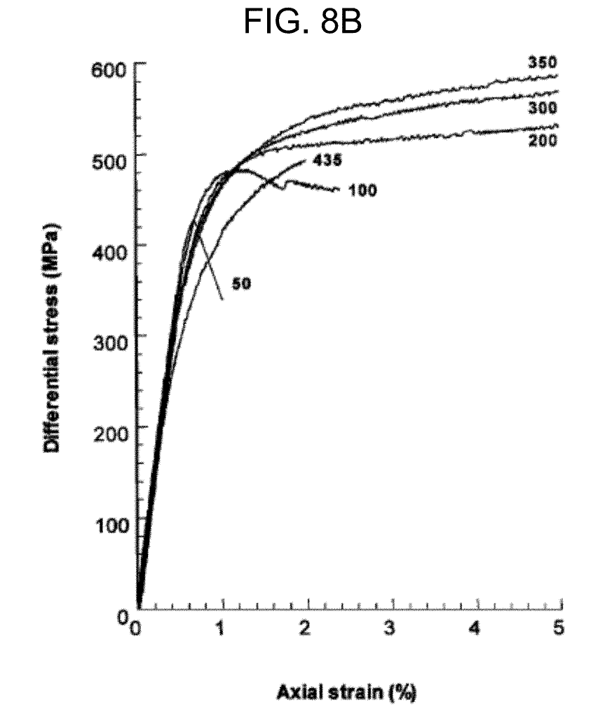

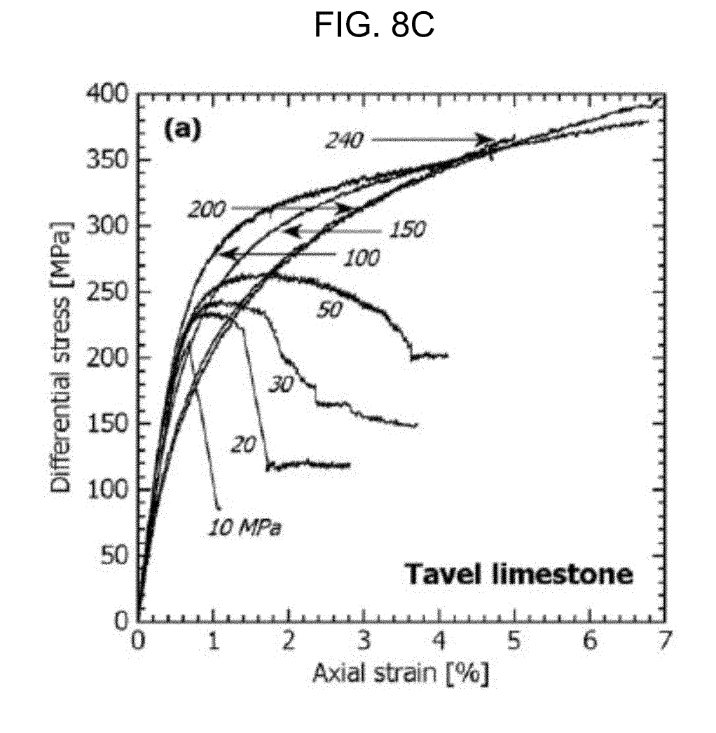

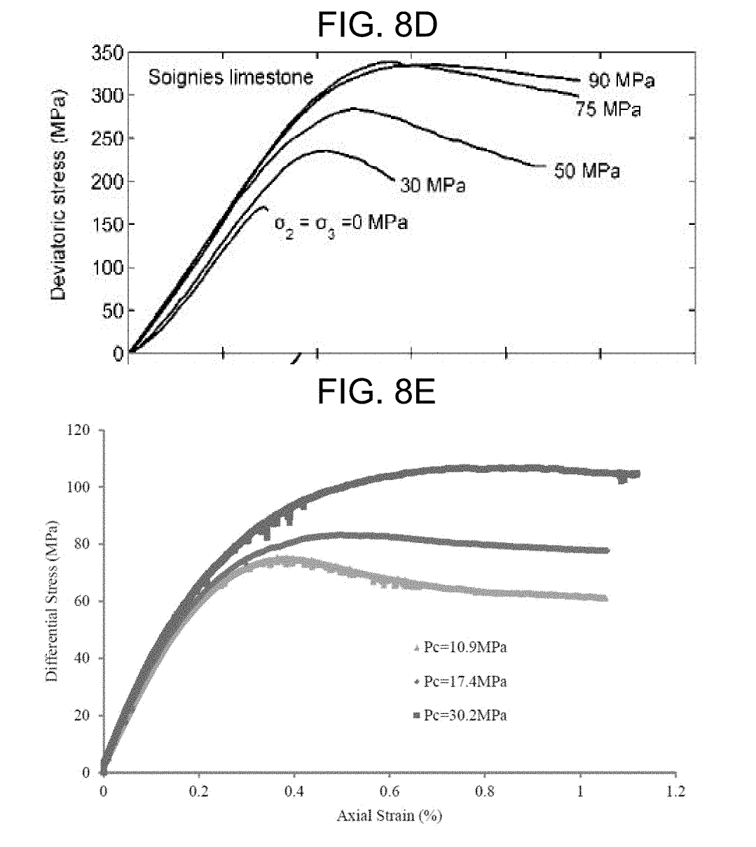

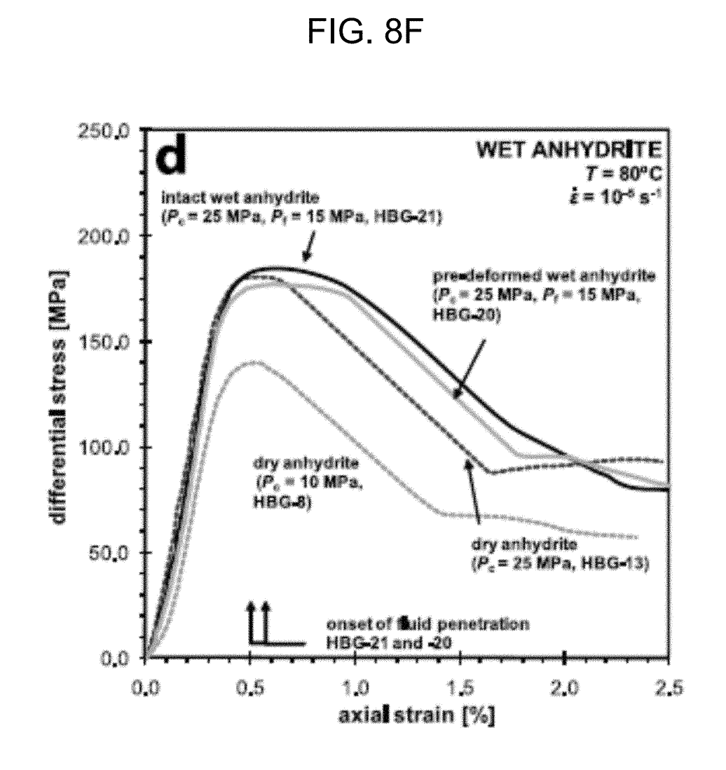

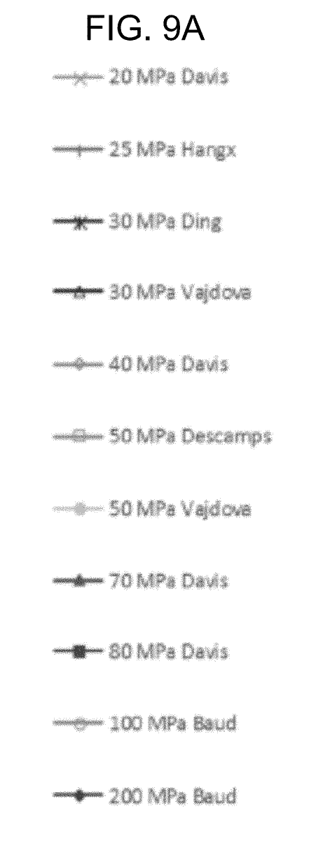

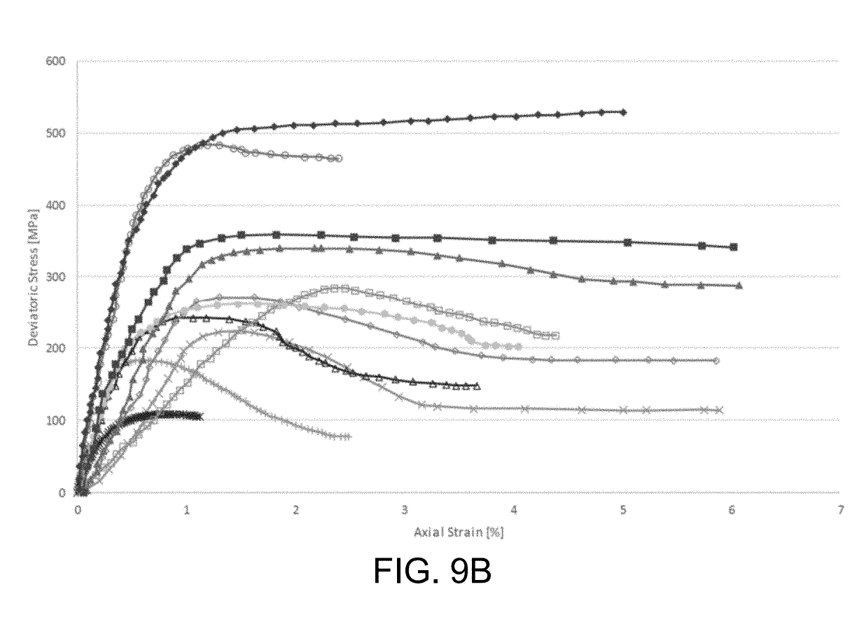

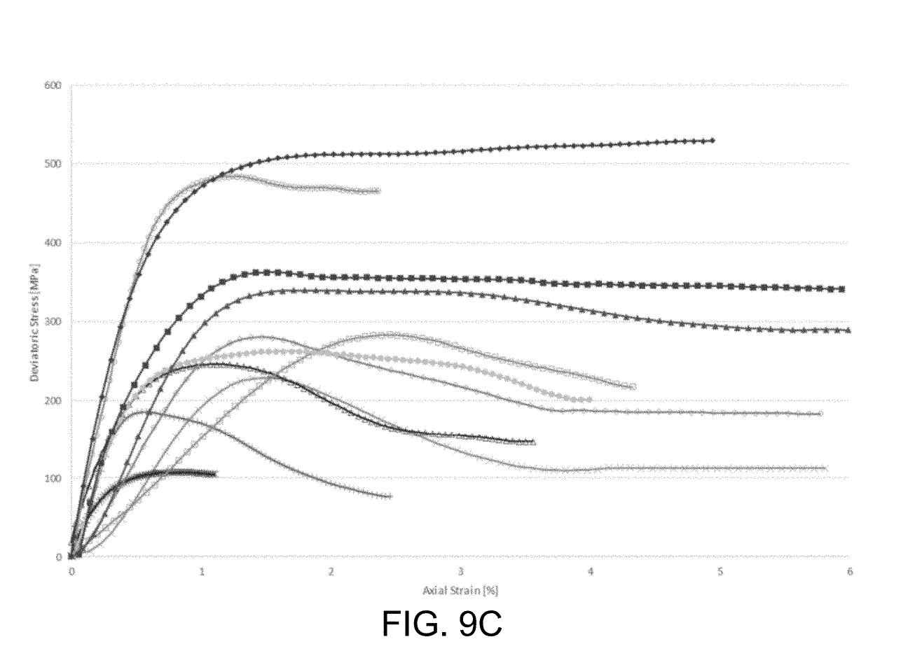

FIG. 1 is a simplified flowchart showing an exemplary technique according to an illustrative embodiment of the present invention. Step 110 involves finding relevant papers in the literature. This may include finding papers which include graphs (e.g. stress-strain curves) regarding a given geomaterial (e.g., sandstone, limestone, etc.) For example, relevant papers for sandstone may include those discussed herein with reference to FIGS. 6-7, while relevant papers for limestone may include those discussed herein with reference to FIGS. 8-9. Step 110 may also include recommending and/or selecting specific graphs within a given paper which are of interest. Step 120 involves extraction of quantitative and/or qualitative data from graphs in the relevant papers. Step 130 involves registration of the extracted data within a knowledge base.

FIG. 2 is a more detailed flowchart showing an exemplary technique according to an illustrative embodiment of the present invention. Step 211 involves a search of scientific papers to find relevant papers. Relevant papers may be, for example, papers which include graphs (e.g., stress-strain curves) regarding a given geomaterial. This search may be fully automated, or it may involve input 241 from a user 240. For example, candidate papers could be automatically determined, then presented to a user who makes the final selection(s). Step 212 involves recommending and/or selecting specific graphs within a given paper which are of interest. This search may be fully automated, or it may involve input 241 from a user 240. For example, candidate graphs could be automatically determined, then presented to a user who makes the final selection(s). Steps 211 and 212 in FIG. 2 collectively correspond to step 110 in FIG. 1.

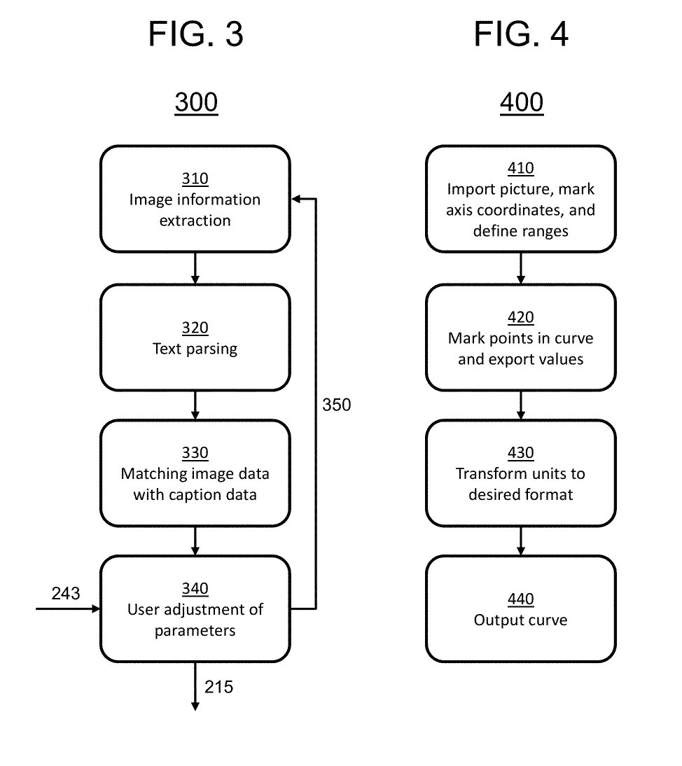

Step 220 involves information extraction from each chart. Step 220 may receive input 243 from the user 240. Step 220 may provide cognitive feedback 215 to improve step 212. Step 220 corresponds to step 120 in FIG. 1. Step 220 is described in further detail below with reference to FIG. 3. Step 231 involves normalization of chart data (i.e., extracted in step 220) to the same scale and units, thus generating a normalized set of curve data 232. The normalized set of curve data 232 can be used for learnable models 233, and thus for knowledge base registration (e.g., 130 in FIG. 1). The normalized set of curve data may also be provided to visualization user interface (UI) 234, which can provide an output 244 to the user 240.

FIG. 3 is a flowchart showing an exemplary process 300 for information extraction according to an illustrative embodiment of the present invention. The steps in process 300 are performed for each of the charts selected in step 212. Step 310 involves image information extraction and/or image-based content analysis, such as curve fitting and/or optical character recognition (OCR).

Step 320 involves text parsing, such as natural language processing (NLP). It is important to note that there may be naming variation, such that different papers may use different terms to identify the same concept. For example, the y-axes of each of the graphs in FIGS. 6-9 are measuring the same value: the terms “deviatoric stress” (used in, e.g., FIG. 8D); “differential stress” (used in, e.g., FIGS. 6A-6D); and “σ₁-σ₃” (used in, e.g., FIG. 6E) are synonymous.

Step 330 involves matching of image data with caption data. Step 340 involves user adjustment of parameters. As discussed above with reference to FIG. 2, step 340 may include receiving input 243 from user 240, and providing cognitive feedback 215 to chart selection step 212. After step 340, the process returns 350 to step 310 and repeats for the next chart.

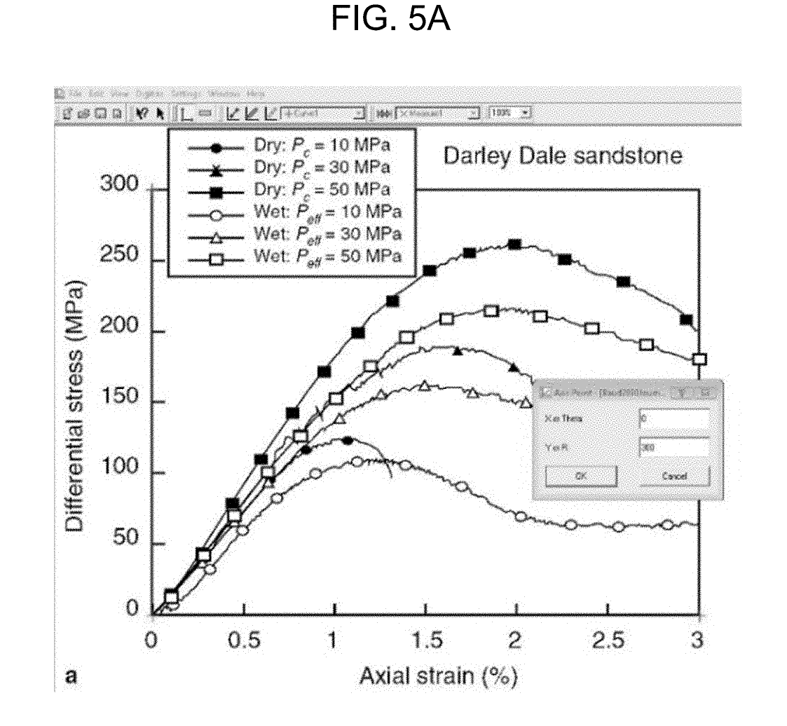

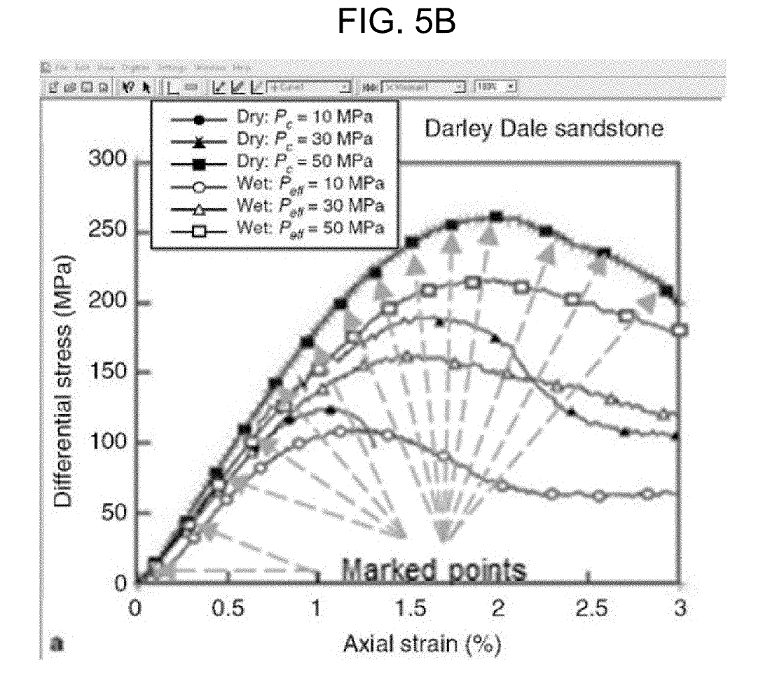

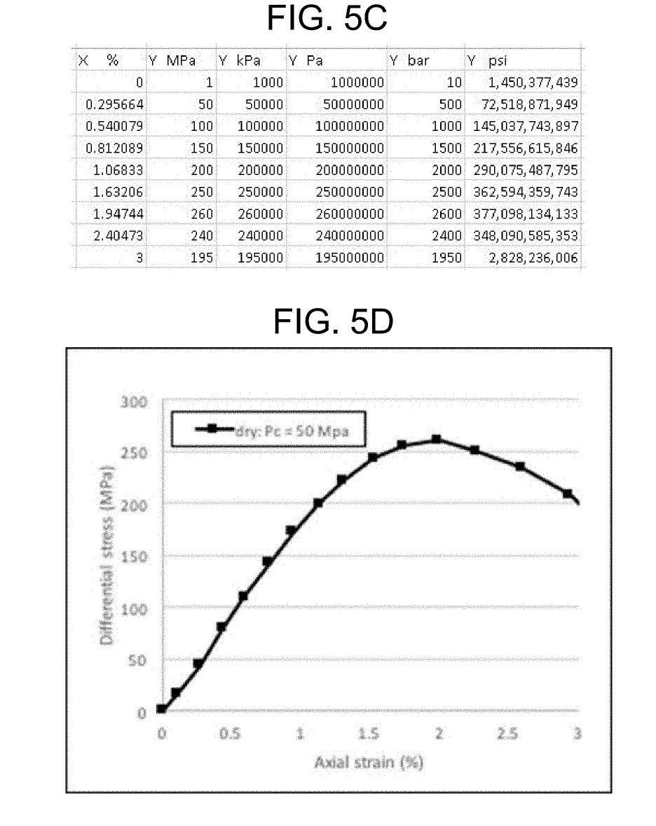

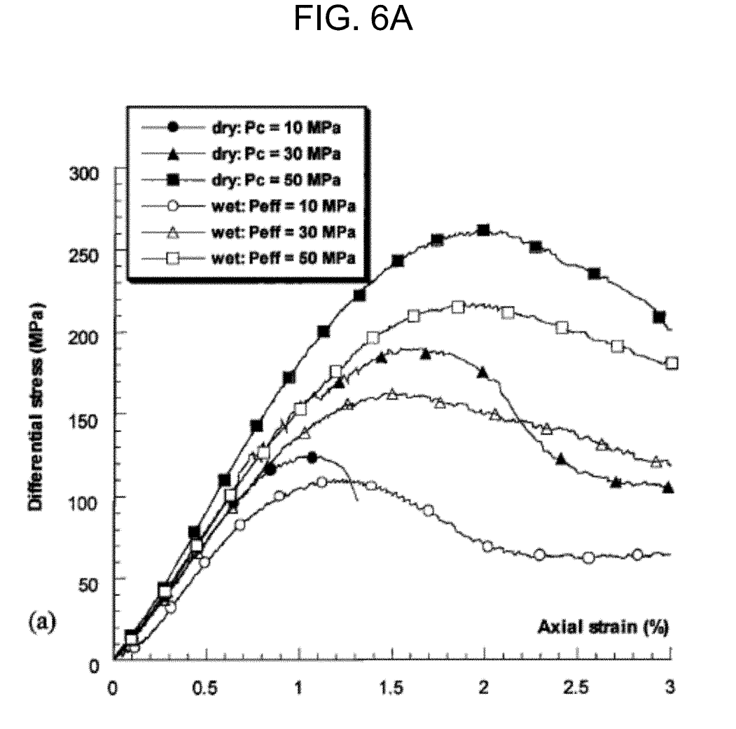

FIGS. 4 and 5 show another exemplary technique 400. Specifically, FIG. 4 is an exemplary flowchart showing technique 400. FIGS. 5A-5D show exemplary screenshots associated with respective steps of the technique 400 shown in FIG. 4. In contrast to conventional techniques in which these steps are performed manually by a user, one or more of these steps may be advantageously performed automatically by a computer in illustrative embodiments of the present invention.

Step 410 in FIG. 4 includes importing a picture, marking axis coordinates, and defining ranges. FIG. 5A is an exemplary screenshot associated with an illustrative embodiment of step 410. In this example, the picture which has been imported is FIG. 1(a) on page 16,373 of P. Baud et al., “Failure mode and weakening effect of water on sandstone,” Journal of Geophysical Research, July 2000, v. 105, n. B7, p. 16,371-16,389, which is further discussed below with reference to FIG. 6A. There is a window which allows the user to enter an “Axis Point” value of “X” and “Y.” Step 410 in FIG. 4 broadly corresponds to step 212 in FIG. 2.

Step 420 in FIG. 4 includes marking points in a curve and exporting values. FIG. 5B. FIG. 5B is an exemplary screenshot associated with an illustrative embodiment of step 420. In this example, the marked points are values on a strain-stress curve for dry Darley Dale sandstone with a confining pressure (P_{c}) of 50 MPa. Step 420 in FIG. 4 broadly corresponds to step 220 in FIG. 2.

Step 430 in FIG. 4 includes transforming units to the desired format. FIG. 5C is an exemplary screenshot associated with an illustrative embodiment of step 430. In FIGS. 5A and 5B, the strain (X-axis) is measured in percent (%), and the stress is measured in megapascals (MPa). However, in FIG. 5C, the stress for each of the marked points is also converted into various other units, including kilopascals (kPa), pascals (Pa), bar and pounds per square inch (psi). Step 430 in FIG. 4 broadly corresponds to step 231 in FIG. 2.

Step 440 in FIG. 4 includes outputting the curve. FIG. 5D is an exemplary screenshot associated with an illustrative embodiment of step 440. Step 440 in FIG. 4 broadly corresponds to element 232 in FIG. 2. In this example, the output is a normalized strain-stress curve for dry Darley Dale sandstone with a confining pressure (P_{c}) of 50 MPa.

As discussed in the prior application with reference to FIGS. 7 and 8, different variants of a given geomaterial will have different strain-stress curves. For example, Indiana limestone and Solenhofen limestone will have different strain-stress curves. Moreover, as discussed below, a given reference may often include multiple stress-strain curves for a given geomaterial variant reflecting different conditions (e.g., different pressures, wet vs. dry, etc.) Thus, illustrative embodiments of the present invention may be utilized to use scientific literature to construct a knowledge base including stress-strain curves for a given geomaterial (e.g., sandstone or limestone), including different variants, different conditions, etc.

FIGS. 6A-6E represents stress-strain curves found in the literature for different variants of sandstone under various conditions. The figures are ordered by the age of the reference, with the oldest reference appearing first.

FIG. 6A is a reproduction of FIG. 1(a) on page 16,373 of P. Baud et al., “Failure mode and weakening effect of water on sandstone,” Journal of Geophysical Research, July 2000, v. 105, n. B7, p. 16,371-16,389, the entire disclosure of which is hereby incorporated by reference herein for all purposes. FIG. 6A shows strain-stress curves for Darley Dale sandstone (from the United Kingdom) at various pressures under both dry and wet conditions. FIG. 6A shows strain-stress curves for dry Darley Dale sandstone at confining pressures (P_{c}) of 10 MPa, 30 MPa, and 50 MPa. FIG. 6A also shows strain-stress curves for wet Darley Dale sandstone at effective pressures (P_{eff}) of 10 MPa, 30 MPa, and 50 MPa.

FIG. 6B is a reproduction of FIG. 2(a) on page 22 of E. Klein et al., “Mechanical behaviour and failure mode of bentheim sandstone under triaxial compression,” Physics and Chemistry of the Earth (A), 2001, v. 26, n. 1-2, p. 21-25, the entire disclosure of which is hereby incorporated by reference herein for all purposes. FIG. 6B shows strain-stress curves for dry Bentheim sandstone (from Germany) at confining pressures of 10 MPa, 30 MPa, 60 MPa, and 90 MPa.

FIG. 6C is a reproduction of FIG. 2(a) on page 6 of S. Tembe et al., “Stress conditions for the propagation of discrete compaction bands in porous sandstone,” Journal of Geophysical Research, September 2008, v. 113, n. B9, B09409, 16 pages, the entire disclosure of which is hereby incorporated by reference herein for all purposes. FIG. 6C shows strain-stress curves for dry Diemelstadt sandstone (from Germany) at confining pressures (P_{c}) of 2.5 MPa, 5 MPa, 10 MPa, 15 MPa, 20 MPa, 25 MPa, 30 MPa, and 35 MPa.

FIG. 6D is a reproduction of FIG. 3(c) on page 1769 of N. Reviron et al, “The brittle deformation regime of water-saturated siliceous sandstones,” Geophysical Journal International, April 2009, v. 178, n. 3, p. 1766-1778, the entire disclosure of which is hereby incorporated by reference herein for all purposes. FIG. 6D shows strain-stress curves for wet Bentheim sandstone at a constant pore pressure (Pₚ) of 10 MPa and confining pressures (P_{c}) of 12 MPa, 20 MPa, 30 MPa, 40 MPa, 50 MPa, and 60 MPa.

FIG. 6E is a reproduction of FIG. 9.8(a) on page 225 of S. Yang, Strength Failure and Crack Evolution Behavior of Rock Materials Containing Pre-existing Fissures, Chapter 9 (p. 217-246). 2015, the entire disclosure of which is hereby incorporated by reference herein for all purposes. FIG. 6E shows strain-stress curves for red sandstone (from China) at confining pressures of 5 MPa, 10 MPa, 15 MPa, 20 MPa, 25 MPa, and 35 MPa.

FIG. 7A shows the labels that will be used with selected curves for sandstone. The selected sandstone curves include, from FIG. 6A (Baud): 10 MPa wet, 30 MPa wet, 50 MPa dry, and 50 MPa wet. The selected sandstone curves also include, from FIG. 6B (Klein): 10 MPa and 30 MPa. The selected sandstone curves also include 30 MPa from FIG. 6C (Tembe), 60 MPa from FIG. 6D (Reviron), and 35 MPa from FIG. 6E (Yang). FIG. 7B shows selected curves plotted with the set of points from FIGS. 6A-6E for sandstone that can be used for catalog registration. FIG. 7C shows a normalized set of curve data in which FIG. 7B is transformed to the same scale or metrics. These curves can be used as training data, e.g., for a machine learning classifier for fracture classification in a naturally fractured reservoir, as discussed in the prior application.

FIGS. 8A-8F represents stress-strain curves found in the literature for different variants of limestone under various conditions. The figures are ordered by the age of the reference, with the oldest reference appearing first.

FIG. 8A is a reproduction of FIG. 3.38 on page 135 of G. H. Davis et al., “Experimentally Observed Relationships Between Stress and Strain,” Structural Geology of Rocks and Regions, 2nd ed. 1996, p. 122-142, the entire disclosure of which is hereby incorporated by reference herein for all purposes. FIG. 8A shows strain-stress curves for Crown Point limestone (from New York, U.S.A.) at confining pressures of 20 MPa, 40 MPa, 60 MPa, 70 MPa, 80 MPa, 130 MPa, and 140 MPa.

FIG. 8B is a reproduction of FIG. 2 on page 19,290 of P. Baud et al., “Dilatancy, compaction, and failure mode in Solnhofen limestone,” Journal of Geophysical Research, August 2000, v. 105, n. B8, p. 19,289-19,303, the entire disclosure of which is hereby incorporated by reference herein for all purposes. FIG. 8B shows strain-stress curves for Solnhofen limestone (from Germany) at confining pressures of 50 MPa, 100 MPa, 200 MPa, 300 MPa, 350 MPa, and 435 MPa.

FIG. 8C is a reproduction of FIG. 3(a) on page 6 of V. Vajdova et al., “Compaction, dilatancy, and failure in porous carbonate rocks,” Journal of Geophysical Research, May 2004, v. 109, n. B5, B05204, 16 pages, the entire disclosure of which is hereby incorporated by reference herein for all purposes. FIG. 8C shows strain-stress curves for Tavel limestone (from France) at confining pressures of 10 MPa, 20 MPa, 30 MPa, 50 MPa, 100 MPa, 150 MPa, 200 MPa, and 240 MPa.

FIG. 8D is a reproduction of a portion of FIG. 1 on page 598 of F. Descamps et al., “Behaviour of Carbonated Rocks Under True Triaxial Compression,” 12th International Society for Rock Mechanics (ISRM) Congress, 2012, p. 597-602, the entire disclosure of which is hereby incorporated by reference herein for all purposes. FIG. 8D shows strain-stress curves for Tavel limestone (from France) at confining pressures of 0 MPa, 30 MPa, 50 MPa, 75 MPa, and 90 MPa.

FIG. 8E is a reproduction of FIG. 4.7 on page 35 of J. Ding, “Experimental Study on Rock Deformation and Permeability Variation,” M. Sc. Thesis, Petroleum Engineering, Texas A&M University, August 2013, pages 1-74, the entire disclosure of which is hereby incorporated by reference herein for all purposes. FIG. 8E shows strain-stress curves for Indiana limestone (from the United States of America) at confining pressures of 10.9 MPa, 17.4 MPa, and 30.2 MPa.

FIG. 8F is a reproduction of FIG. 8D on page 9 of Hangx et al., “Mechanical behavior of anhydrite caprock and implications for CO2 sealing capacity,” Journal of Geophysical Research, July 2010, v. 115, n. B7, B07402, 22 pages, the entire disclosure of which is hereby incorporated by reference herein for all purposes. FIG. 8F shows strain-stress curves for wet anhydrite and dry anhydrite.

FIG. 9A shows the labels that will be used with the selected curves for limestone. The selected limestone curves include, from FIG. 8A (Davis): 20 MPa, 40 MPa, 70 MPa, and 80 MPa. The selected limestone curves also include, from FIG. 8B (Baud): 100 MPa and 200 MPa. The selected limestone curves further include, from FIG. 8C (Vajdova): 30 MPa and 50 MPa. The selected sandstone curves additionally include 50 MPa from FIG. 8D (Descamps), 30 MPa from FIG. 8E (Ding), and 25 MPa from FIG. 8F (Hangx). FIG. 9B shows the selected curves plotted with the set of points from FIGS. 8A-8F for limestone that can be used for catalog registration. FIG. 9C shows the normalized set of curve data in which FIG. 9B is transformed to the same scale or metrics. These curves can be used as training data, e.g., for a machine learning classifier for fracture classification in a naturally fractured reservoir, as discussed in the prior application.

One or more embodiments of the invention, or elements thereof, can be implemented, at least in part, in the form of an apparatus including a memory and at least one processor that is coupled to the memory and operative to perform exemplary method steps.

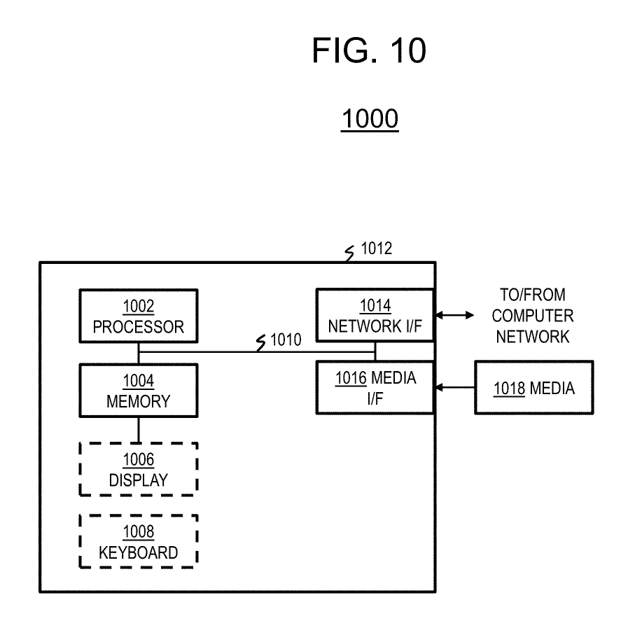

One or more embodiments can make use of software running on a general purpose computer or workstation. With reference to FIG. 10, such an implementation might employ, for example, a processor 1002, a memory 1004, and an input/output interface formed, for example, by a display 1006 and a keyboard 1008. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, one or more mechanisms for inputting data to the processing unit (for example, mouse), and one or more mechanisms for providing results associated with the processing unit (for example, printer). The processor 1002, memory 1004, and input/output interface such as display 1006 and keyboard 1008 can be interconnected, for example, via bus 1010 as part of a data processing unit 1012. Suitable interconnections, for example via bus 1010, can also be provided to a network interface 1014, such as a network card, which can be provided to interface with a computer network, and to a media interface 1016, such as a diskette or CD-ROM drive, which can be provided to interface with media 1018.

Accordingly, computer software including instructions or code for performing the methodologies of the invention, as described herein, may be stored in one or more of the associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 1002 coupled directly or indirectly to memory elements 1004 through a system bus 1010. The memory elements can include local memory employed during actual implementation of the program code, bulk storage, and cache memories which provide temporary storage of at least some program code in order to reduce the number of times code must be retrieved from bulk storage during implementation.

Input/output or I/O devices (including but not limited to keyboards 1008, displays 1006, pointing devices, and the like) can be coupled to the system either directly (such as via bus 1010) or through intervening I/O controllers (omitted for clarity).

Network adapters such as network interface 1014 may also be coupled to the system to enable the data processing system to become coupled to other data processing systems or remote printers or storage devices through intervening private or public networks. Modems, cable modem and Ethernet cards are just a few of the currently available types of network adapters.

As used herein, including the claims, a “server” includes a physical data processing system (for example, system 1012 as shown in FIG. 12) running a server program. It will be understood that such a physical server may or may not include a display and keyboard.

It should be noted that any of the methods described herein can include an additional step of providing a system comprising distinct software modules embodied on a computer readable storage medium; the modules can include, for example, any or all of the elements depicted in the block diagrams or other figures and/or described herein. The method steps can then be carried out using the distinct software modules and/or sub-modules of the system, as described above, executing on one or more hardware processors 1002. Further, a computer program product can include a computer-readable storage medium with code adapted to be implemented to carry out one or more method steps described herein, including the provision of the system with the distinct software modules.

### Exemplary System and Article of Manufacture Details

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1.-18. (canceled)

19. An apparatus, comprising:
a memory; and
at least one processor coupled with the memory, the processor operative:
to select at least one chart within at least a given one of the one or more references;
to extract at least a subset of the geomechanical data in the selected chart;
to prepare one or more learnable models at least in part from the geomechanical data; and
to load the learnable models into the knowledge base for use at least in part by at least one machine learning classifier.

20. A computer program product comprising a non-transitory machine-readable storage medium having machine-readable program code embodied therewith, said machine-readable program code comprising machine-readable program code configured:
to select at least one chart within at least a given one of the one or more references;
to extract at least a subset of the geomechanical data in the selected chart;
to prepare one or more learnable models at least in part from the geomechanical data; and
to load the learnable models into the knowledge base for use at least in part by at least one machine learning classifier.
